(19) United States
(12) Patent Application Publication
(10) Pub. No.: US 2012/0175308 A1
(43) Pub. Date: Jul. 12, 2012

(54) METHOD FOR REMOVING ALKALINITY, HARDNESS, AND DISSOLVED SOLIDS FROM WASTE WATER

(76) Inventors: Juzer Jangbarwala, Chino Hills, CA (US); Mike Smith, Upland, CA (US); Keith Morlock, Upland, CA (US); Bob Glaser, Upland, CA (US)

(21) Appl. No.: 13/427,713

(22) Filed: Mar. 22, 2012

Related U.S. Application Data
(63) Continuation-in-part of application No. 12/460,956, filed on Jul. 27, 2009, now Pat. No. 8,168,068.

(51) Int. Cl. C02F 1/42; B01D 19/00; B01D 15/04; B01J 47/02; B01J 49/00

(52) U.S. Cl. 210/664; 210/681; 210/670; 210/685; 210/673

(57) ABSTRACT

A highly efficient method for treating contaminated water streams from any source where alkanlinity, hardness, or dissolved solids need to be removed before the water is discharged to the surrounding environment or sent to a secondary treatment facility.

### CROSS-REFERENCE TO RELATED APPLICATIONS

This Application is a Continuation-in-Part of U.S. patent application Ser. No. 12/460,956, filed on Jul. 27, 2009, by Juzer Jangbarwala, entitled Treatment Of Contaminated Water Streams From Coal-Bed-Methane Production, the contents of which are expressly incorporated herein by this reference as though set forth in its entirety, and to which priority is claimed.

### FIELD OF THE INVENTION

The present invention relates to methods for treating contaminated waters. Specifically, the present invention is a water treatment method for removing alkalinity, hardness, or dissolved solids before the water is discharged to the surrounding environment.

### BACKGROUND OF THE INVENTION

Coal bed methane (CBM) is methane gas that is found in coal seams. Generally, CBM is produced by non-traditional means, and therefore, while CBM is sold and used the same as traditional natural gas, production of CBM is different. CBM is generated either from a biological process resulting from microbial action or a thermal process resulting from increased heat with depth of the coal.

CBM wells have increasingly been developed throughout the United States and other parts of the world. Typically, CBM wells are drilled into coal seams, and the CBM wells' ground water is withdrawn to reduce the hydrostatic pressure on the coal seam. The reduced hydrostatic pressure allows methane gas to migrate towards the well bore where the methane gas moves to the surface and is collected. Where possible, operators preferably discharge the ground water into nearby streams, rivers, or other surface water bodies. Depending on the chemical characteristics of the ground water, operators apply different levels of treatment to the ground water before discharge. In some locations, such water cannot be discharged and is instead injected, reused, or evaporated.

CBM water typically has an elevated pH as well as high levels of bicarbonates and sodium. It is not unusual to find CMB water with about 300 to 5000 ppm of bicarbonates and about 200 to 2000 ppm of sodium. Water with these characteristics is detrimental to soil, crops, and turf. High bicarbonate/high sodium water is also detrimental because it tends to plug soil pore spaces and therefore prevents adequate moisture and nutrients from reaching the root structure of crops and grasses.

With potable water resources in the United States and other parts of the world becoming increasing scarce, an important environmental challenge is to economically treat and utilize CBM water. One method that is currently utilized is to irrigate land with CBM water and subsequently spread sulfur and gypsum on the land in an attempt to counteract the deleterious effects of bicarbonates and sodium. Such a method has several drawbacks. For example, it is difficult to spread gypsum and sulfur on irrigated land in a uniform, consistent, and cost-effective manner, especially during austere weather conditions. Moreover, it is doubtful that such a method effectively solves the problems associate with high bicarbonates and sodium. Spreading sulfur on land that is irrigated water having high levels of bicarbonate may do little to reduce the level of bicarbonates in soil on a consistent basis. Although research supports the use of gypsum in leaching sodium through the soil profile, the benefit of gypsum is greatly lessened when high levels of bicarbonates are present. Adding calcium via gypsum to soil being irrigated with high-bicarbonate or high carbonate water can result in the formation of calcium carbonate. Not only does calcium carbonate further aggravate soil problems, but less calcium is available to displace the sodium.

Sodium removal is important for the treatment of these contaminated water streams and can be achieved by various methods. One such method is by ion exchange. There are two types of ion-exchange mechanisms available for water with sodium associated with alkalinity (any alkalinity-OH, CO3, HCO3, etc.)—strong acid cation exchange and weak acid cation exchange. Strong acid cation exchange is typically achieved by exchanging hydrogen ions or protons for the sodium via a sulfonic group on a polystyrene backbone crosslinked with divinylbenze. This type of exchange can split a salt and replace the cation (in this case sodium) with a proton, creating an acid of the anion that is left. Recovery rates are typically only about 85%. Weak acid cation exchange is typically achieved by neutralizing the alkalinity through exchange of the cation associated with the alkalinity (in this case sodium) with a proton, thus producing water or water and CO2. Recovery rates can be as high as 90% and even higher, due to selective behavior and higher capacity. If anionic constituents are to be removed from the process stream, then a strong base anion resin can be added to treat the effluent of the strong acid cationic resin bed to provide an essentially ion free treated water product.

Conventional ion exchange utilizes the resins as described above and is well known throughout the water treatment industry. The process used to regenerate the resin in conventional ion exchange will generate between 6 to 10 bed volumes of waste per regeneration, where one bed volume is equal to the volume of resin in the ion exchange vessel.

Reverse osmosis can also be used for removing sodium ions from an aqueous solution. Reverse osmosis has the disadvantage of not being selective. It also requires relatively high pressure on the contaminated water side, resulting in a stream that is essentially a substantially salt-free permeate. Recovery rates vary, but they typically range from about 65% to about 90%, depending on various factors, such as salinity and pressure.

While various methods have been used with limited success in treating contaminated water streams containing high alkalinity or hardness such as streams resulting from the production of coal-bed-methane, there remains a need in the art for improved methods from both a technical as well as from an economical point of view.

### SUMMARY OF THE INVENTION

To minimize the limitations in the prior art, and to minimize other limitations that will become apparent upon reading and understanding the present specification, the present invention discloses a new and useful method for removing alkalinity, hardness, and dissolved solids from waste water.

One embodiment of the present invention is a method for treating a contaminated water stream, the steps comprising: providing at least one reaction vessel; providing at least one transfer pump; wherein the at least one transfer pump furnishes a water and a regeneration flow to the at least one reaction vessel; introducing the contaminated water stream into the at least one reaction vessel; wherein the contaminated water contacts one or more ion exchange resin beads at an effective downflow rate sufficient to exchange one or more hydrogen ions of the exchange resin beads, such that a cation exchanged treated water stream is produced; conducting the cation exchanged treated water stream from the at least one reaction vessel; and stopping a flow of the contaminated water stream to the at least one reaction vessel when the one or more ion exchange resin beads is exhausted. The method for treating a contaminated water stream may further comprising the step of: regenerating the one or more ion exchange resin beads. The at least one reaction vessel may contain one or more bed volumes of weak acid. Preferably, the one or more bed volumes of weak acid is approximately half of the at least one reaction vessel. Preferably, the at least one reaction vessel contains one or more bed volumes of strong acid cation exchange resin beds. The at least one reaction vessel of the one or more bed volumes of strong acid cation exchange resin beds may be approximately three quarters full. Preferably, the method for treating a contaminated water stream, further comprising the step of: removing one or more anions by providing an anion reaction vessel in series with the one or more bed volumes of strong acid cation exchange resin beds; and wherein the anion reaction vessel is filled with a strong base resin in proportion to a level of an anionic loading. Preferably, the method for treating a contaminated water stream, further comprising the step of: introducing the contaminated water through a strong base anion reaction vessel. Preferably, the at least one reaction vessel is introduced to a degassifier. The regenerating step preferably comprises the steps of: backwashing the exhausted one or more ion exchange resin beads at approximately 50% of the process flow; draining the at least one reaction vessel of the water into a contaminated water holding area; providing at least two ion exchange resin bed volumes of acid regenerant solution in an acid mix tank; introducing into the one or more ion exchange resin beads the at least two ion exchange resin bed volumes of acid regenerant solution from the acid mix tank; draining the at least one reaction vessel; filling the at least one reaction vessel with a rinse water; introducing a second of at least two resin bed volumes with the rinse water; restarting a downflow of the contaminated water through the regenerated one or more ion exchange resin beads; and repeating the regenerating step.

Another embodiment of the present invention is a method for treating a contaminated water stream, the steps comprising: providing at least one reaction vessel; providing at least one transfer pump; wherein the at least one transfer pump furnishes a water and a regeneration flow to the at least one reaction vessel; introducing the contaminated water stream through a main transfer pump from a contaminated water holding area into the at least one reaction vessel; wherein the contaminated water contacts one or more ion exchange resin beads at an effective downflow rate sufficient to exchange one or more hydrogen ions of the exchange resin beads, such that a cation exchanged treated water stream is produced; conducting the cation exchanged treated water stream from the at least one reaction vessel to a treated water holding area; stopping a flow of the contaminated water stream to the at least one reaction vessel when the one or more ion exchange resin beads is exhausted; and regenerating the one or more ion exchange resin beads. The at least one reaction vessel may contain one or more bed volumes of weak acid; wherein the one or more bed volumes of weak acid are substantially spherical. The one or more bed volumes of weak acid should be approximately half of the at least one reaction vessel; wherein the one or more bed volumes of weak acid is encompassed by one or more surrounding walls of the at least one reaction vessel. Preferably, the at least one reaction vessel contains one or more bed volumes of strong acid cation exchange resin beds; and wherein the one or more bed volumes are substantially spherical. The at least one reaction vessel of the one or more bed volumes of strong acid cation exchange resin beds is preferably approximately three quarters full. Preferably, the method for treating a contaminated water stream further comprising the step of: removing one or more anions by providing an anion reaction vessel in series with the one or more bed volumes of strong acid cation exchange resin beds; wherein the anion vessel is filled with a strong base resin in proportion to a level of anionic loading. Preferably, the method for treating a contaminated water stream further comprising the step of: introducing the contaminated water through a strong base anion reaction vessel. Preferably, the at least one reaction vessel is introduced to a degassifier. The regenerating step preferably comprises the steps of: backwashing the exhausted one or more ion exchange resin beads at approximately 50% of the process flow; draining the at least one reaction vessel of the water into a contaminated water holding area; providing at least two ion exchange resin bed volumes of an acid regenerant solution in an acid mix tank; introducing into the one or more ion exchange resin beads the at least two exchange bed volumes of the acid regenerant solution from the acid mix tank; draining the at least one reaction vessel; introducing a second of resin bed volumes of the acid regenerant solution; draining the at least one reaction vessel a second time; introducing one bed volume of a rinse water into the at least one reaction vessel and into the resin bed volumes of the acid regenerant solution; draining the at least one reaction vessel a third time; filling the at least one reaction vessel with the rinse water; introducing at least two resin bed volumes with the rinse water; introducing an additional two resin bed volumes of rinse water from the contaminated water holding area; restarting a downflow of the contaminated water through the regenerated one or more ion exchange resin beads; and repeating the regenerating step whenever the one or more ion exchange resin beads becomes exhausted.

Another embodiment of the present invention is a method for treating a contaminated water stream, the steps comprising: providing at least one reaction vessel; wherein the at least one reaction vessel contains one or more bed volumes of strong acid cation exchange resin beds; wherein the one or more bed volumes of strong acid cation exchange resin beds are substantially spherical; wherein the at least one reaction vessel of the one or more bed volumes of strong acid cation exchange resin beds is approximately three quarters full; providing an anion reaction vessel in series with the one or more bed volumes of strong acid cation exchange resin beds; wherein the anion vessel is filled with a strong base resin in proportion to a level of anionic loading; providing at least one transfer pump; wherein the at least one transfer pump includes the at least one reaction vessel to furnish a water and a regeneration flow to the at least one reaction vessel; introducing the contaminated water stream into the at least one reaction vessel; introducing the contaminated water through a strong base anion reaction vessel; wherein the contaminated water contacts one or more ion exchange resin beads at an effective downflow rate sufficient to exchange one or more hydrogen ions of the exchange resin beads for one or more cations of the contaminated waters stream, such that a cation exchanged treated water stream is produced; wherein the at least one reaction vessel is introduced to a degassifier; conducting the cation exchanged treated water stream from the at least one reaction vessel to a treated water holding area; stopping a flow of the contaminated water stream to the at least one reaction vessel when the one or more ion exchange resin beads is exhausted; regenerating the one or more ion exchange resin beads, the regenerating step comprises the steps of: backwashing the exhausted one or more ion exchange resin beads at approximately 50% of the process flow; draining the at least one reaction vessel of the water into a contaminated water holding area; providing at least two ion exchange resin bed volumes of acid regenerant solution in an acid mix tank; introducing into the one or more ion exchange resin beads the at least two ion exchange resin bed volumes of acid regenerant from the acid mix tank; draining the at least one reaction vessel; introducing a second resin bed volume of the acid regenerant solution; draining the at least one reaction vessel a second time; introducing at least one bed volume of a rinse water into the at least one reaction vessel and into the at least two ion exchange resin bed volumes of the acid regenerant solution; draining the at least one reaction vessel a third time; filling the at least one reaction vessel with the rinse water; introducing a second of at least two resin bed volumes of rinse water from the contaminated water holding area; restarting a downflow of the contaminated water through the regenerated one or more ion exchange resin beads; and repeating the regenerating step whenever the one or more ion exchange resin beads becomes exhausted.

Another embodiment of the present invention is a method for treating a contaminated water stream, the steps comprising: (1) providing at least one reaction vessel containing a bed volume of weak acid or strong acid cation ion exchange resin beads of substantially uniform spherical size. For weak acid resin, the bed volume will be about half the volume of the reaction vessel volume between a top header-lateral distributor and a bottom header-lateral distributor and encompassed by surrounding walls of said vessel, and wherein the space between the resin beads is the void volume. For strong acid resin, the reaction vessel will be filled up to three quarters full. If anion removal is needed (i.e., chloride removal), then an anion reaction vessel shall be placed in series with the cation reaction vessel. The anion vessel will be filled with strong base resin in proportion to the level of anionic loading; (2) providing one transfer pump with each reaction vessel to furnish the water and regeneration flow to the said reaction vessel. Each pump will be equipped with a variable frequency drive (VFD) to allow the pump to run from 10% to 100% of full process flow. The flow for regeneration will be at 25% and backwash will be at 50% of full process flow; (3) introducing said contaminated water stream via the main transfer pump at 100% flow, from a contaminated water holding area, into the top of said cation reaction vessel wherein it flows downward through said top header-lateral distributor and contacts said ion exchange resin berads at an effective downflow rate sufficient to result in the exchange of hydrogen ions of the exchange resin for positive ions (cations) of the contaminated waters stream, thereby resulting in an ion exchanged treated water stream having a reduced level of sodium, calcium, magnesium, and other major cations associated with alkalinity and hardness. If added dissolved solids removal is required due to high salt content, then the contaminated water will be introduced through a strong acid cation followed by a strong base anion reaction vessel; (4) conducting said cation exchanged treated water stream from said cation reaction vessel to a treated water holding area. If anionic removal is required then the effluent from the cation reaction vessel will be introduced to a degassifier or directly into the anion reaction vessel and then to the treated water holding area. Degassification is only needed if excessive CO2 gas is produced in the cation reaction vessel; (5) stopping the flow of the contaminated water stream to said reaction vessel(s) where the ion exchange resin becomes substantially exhausted, thereby resulting in said bed of ion exchange resin containing untreated contaminated water within the void volume of the resin bed; (6) regenerating said bed of weak or strong cation exchange resin by: (i) backwashing said bed of exhausted cation exchange resin at 50% of the process flow via the main stransfer pump, with two bed volumes of filtered water from the contaminated water holding area by introducing the water into the bottom distributor and through the exhausted cation exchange resin thereby displacing any suspended particulate impurities in said resin bed and passing the displaced untreated contaminated water and substantially all suspended particulate impurities back to the contaminated water holding area; (ii) draining said reaction vessel of all water via the main transfer pump back to the contaminated water holding area; (iii) providing two ion exchange resin bed volumes of acid regenerant solution in an acid mix tank (AMT); (iv) introducing into the bottom of said ion exchange vessel and into said backwashed bed of exhausted cation exchange resin one bed volume of acid regenerant from the acid mix tank at 25% of process flow via the main transfer pump to expose the resin bed to the acid regenerant and exchange hydrogen ions for sodium, calcium, magnesium and other cations held by the ion exchange resin, thereby resulting in a first resin bed volume of acid regenerant containing a high concentration of salts (i.e., sodium sulfate); (v) draining said reaction vessel via the main transfer pump and discharging the first bed volume of highly concentrated acid regenerant solution to the regenerant waste holding area; (vi) introducing the second resin bed volume of acid regenerant solution at 25% of process flow via the main transfer pump from the acid mix tank (AMT) into the bottom of said reaction vessel and into said resin bed thereby resulting in the second resin bed volume of acid regenerant containing a high concentration of salts; (vii) draining said reaction vessel via the main transfer pump and discharging the second bed volume of highly concentrated acid regenerant solution to the regenerant waste water holding area; (viii) introducing one bed volume of rinse water via the main transfer pump at 25% of process flow from the rinse tank (RT) into the bottom of said reaction vessel and into said resin bed; (xi) draining said reaction vessel via the main transfer pump and discharging the third bed volume of diluted regenerant solution to the regenerant waste water holding area; (x) introducing one resin bed volume of rinse water from the rinse tank (RT) into the bottom of said reaction vessel and into said resin bed thereby filling the said reaction vessel with rinse water; (xi) introducing two resin bed volumes of rinse water via the main transfer pump at 25% of process flow from said contaminated water holding area into the top of said reaction vessel and into said resin bed and displacing two resin bed volumes of water into the acid mix tank (AMT). At the same time introducing make-up acid into said acid mix tank (AMT) of sufficient strength and quantity to bring the acid regenerant to a predetermined strength and level for the next regeneration cycle; (xii) introducing an additional two resin bed volumes of rinse water from said contaminated water holding area via the main transfer pump at 50% of process flow into the top of said reaction vessel and through said resin bed and displacing two bed volumes of regenerant rinse solution into the rinse tank (RT); (xiii) restarting the downflow of contaminated water through said regenerated resin bed via the main transfer pump at 100% process flow; and (xiv) repeating steps e and f whenever the resin bed becomes exhausted.

It is an object of the present invention to provide a highly efficient means of treating water streams contaminated with high alkalinity, hardness, or dissolved solids. As compared to conventional ion exchange which generates six to ten resin bed volumes of waste, it is an object of the present invention to provide a method that generates two to three bed volumes of waste by reusing the rinse water in the acid mix tank and rinse water tank. Additional reduction in waste can be achieved via evaporation or crystallization of the regenerant waste.

It is an object of the present invention to use highly selective uniform resin bead sized resins to improve the performance of ion exchange which will further reduce the percentage of waste water generated in the process.

It is an object of the present invention to provide a method that will improve the ion exchange efficiency by at least 30% and reduce the waste volume produced by at least 50% as compared to conventional ion exchange processes.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of the method for treating waste water and shows when the ion exchange resin bed is in service and when contaminated water is passed downward through the resin bed and into the treated water holding area.

FIG. 2 is a block diagram of one embodiment of the method for treating waste water and shows the backwashing of the resin bed with an up-flow of filtered water.

FIG. 3 is a block diagram of one embodiment of the method for treating waste water and shows the water draining from the reaction vessel.

FIG. 4 is a block diagram of one embodiment of the method for treating waste water and shows the pumping of regenerant from the acid mix tank into the resin bed.

FIG. 5 is a block diagram of one embodiment of the method for treating waste water and shows the drain sequence of the regenerant liquid.

FIG. 6 is a block diagram of one embodiment of the method for treating waste water and shows the first rinse step.

FIG. 7 is a block diagram of one embodiment of the method for treating waste water and shows the introduction of two bed volumes of rinse water that is discharged into the acid mix tank.

FIG. 8 is a block diagram of one embodiment of the method for treating waste water and shows the introduction of two bed volumes of rinse water that is discharged into the rinse tank.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

The present invention preferably uses ion exchange for selective contaminant removal, particularly for the removal of alkalinity based sodium compounds from contaminated water sources. The production of waste water is typically minimized and a relatively small amount of acid is usually required for regeneration of the ion exchange resin compared to conventional ion exchange methods for treating waste water streams.

The method of the present invention is preferably capable of treating water contaminated with sodium carbonates, sodium bicarbonates and hardness that result from the production of coal-bed-methane and other deep well produced water. Recovery of substantially uncontaminated water is preferably maximized and the volume of waste water produced is preferably minimized Practice of the present invention typically treats the contaminated water stream to a suitable discharge limit and preferably generates a waste product that can be used as a commercial feedstock. For example, when sulfuric acid is used as the regenerant, the waste water stream resulting from the practice of the present invention should be comprised primarily of sodium sulfate decahydrate (Glauber's salt). This waste water stream, because of its relatively small volume, will preferably be concentrated and thus crystallization/precipitation of sodium sulfate salts can usually be initiated with minimal evaporation. The resulting wet sodium sulfate salt product can be sold to a third party having a need for the same. Because of the relatively small concentrated form of reusable waste generated by the practice of the present invention, transportation is usually minimized and acceptability of it as a feedstock by third parties is typically increased.

The main ion exchange resins used in the practice of the present invention are preferably weak acid cation (WAC) resins that are optimized for low levels of waste generation per volume of contaminated water treated. WAC resins are typically made from acrylic polymers crosslinked with divinyl benzene and preferably functionalized with carboxylic acid exchange groups. WAC resins are typically available as gel type (with microporosity) or macroporous type (with discrete porosity). The macroporous type is typically preferred. The largely unsaturated structure of the acrylic matrix typically permits a very high concentration of carboxylic exchange groups. The high internal concentration of exchange groups preferably causes WAC resins to swell very significantly when exchanging (very small) hydrogen for larger ions, such as sodium. For example, WAC resins can expand up to about 100% in volume. This property of WAC exchange resins generally makes it very difficult for them to be used in currently available minimum waste systems. Applicant hereof has unexpectedly found that by the practice of the present invention a minimum amount of acid regenerant is typically used and a minimum amount of waste is typically produced when compared to conventional ion exchange/regeneration systems. For example, convention practice is preferably to use about 10 resin bed volumes of rinse water after acid treatment of the resin bed and to typically discard the entire 10 volumes of rinse water. Practice of present invention typically uses a relatively small amount of rinse water, some of which is recycled. A relatively small amount of rinse water is usually used is because the resin beads used in the practice of the instant invention are of substantially uniform size. The amount of rinse water needed should be further reduced by use of the preferred resins of the present invention that will have a substantially solid core with an outer porous active surface layer. Also, weak acid groups such as carboxylic groups are typically regenerated easily with dilute acids, because of their high preference for protons. The regenerant may be high in salts, but should be able to regenerate the resin beads as long it has the free mineral acidity and a pH level lower than the pKa of the resin. Therefore, practice of the present invention typically allows for the regeneration of the ion exchange resin with a used acid solution from a previous cycle by typically adding approximately 105 wt. % to 150 wt. % excess of stoichiometric requirement, until such time that the salts formed are near saturation, then bleeding of 2 to 3 bed volumes of the regenerant waste.

Typically, at least about 70%, preferably at least about 75%, and more preferably at least about 80% less regeneration waste is generated by the practice of the present invention compared to conventional methods. The present invention can also utilize strong acid cation or strong base anion resins to remove additional dissolved solids/ionic loading to meet discharge limits. Strong acid cation (SAC) or strong base anion (SBA) resins will typically generate about twice the amount of waste as the weak acid resin described above.

It is preferred that the ion exchange resin be a resin with fast kinetics. Preferred resins include those manufactured by Purlolite, located in Bala Cynwyd, Pa., including Purolite SST resins and Purolite C-100-FM resins. Generally, these Purolite resins are classified as “Fine Mesh” resins and have relatively small diameter bead sizes that may range from about 16 US mesh to about 70 US mesh. The Purolite SST resins, such as SST-60, should have fast kinetics because the ion exchange region is typically only on the surface of the bead. That is, these resins should have a solid core with a porous active outer surface. Such resins are typically known in the industry as Shallow Shell or Shortened Diffusion Path (SDP) resins. The Purolite C-100-FM resin usually has fast kinetics because of its small bead size. It should be understood that the present invention contemplates the use of ion exchange resins as having both standard and very fast kinetics, as well as ion exchange resins that are similar or equivalent to the Purolite versions. These resins preferably will be functionalized to function as weak acid cation exchange resins.

Ion exchange vessels capable of containing a column of ion exchange resin are well known in the art. Such vessels, which are also sometimes referred to as ion exchange columns, preferably: (1) contain and support the ion exchange resin, which is preferably in the form of a fixed-bed; (2) substantially uniformly distribute the service and regeneration flow through the resin bed; (3) provide space to fluidize the resin during backwash; and include the piping, valves, and instruments needed to regulate flow of feed, regenerant, and backwash fluids.

A vessel of suitable size is typically loaded to only about ½ volume capacity with a WAC resin and ¾ volume capacity for SAC or SBA resins of the present invention. This will preferably allow for volume expansion during the service cycle. It is preferred that the ion exchange resin used in the practice of this invention have beads of substantially uniform size in the range of approximately 1%<40 mesh screen size and approximately 5%>25 mesh screen size. This will typically allow for the regeneration solution and rinse water to pass through the resin bed without significant obstruction. It is preferred that the contaminated water being treated be introduced into the vessel at relatively low velocities so that the resin bed effectively removes ions from the feed stream and expands upward as the resin expands and becomes exhausted. Flow rates for the contaminated water entering the column will typically be at effective flow rates. By “effective flow rates” we usually mean that level of flow rate sufficient to result in the exchange of hydrogen ions of the exchange resin for sodium ions of the contaminated water stream. Typically, this flow rate will be form about 3 to 8 gallons per minute per square food of resin vessel surface area, preferably from about 5 to 7 gallons per minute per square foot of resin vessel surface area.

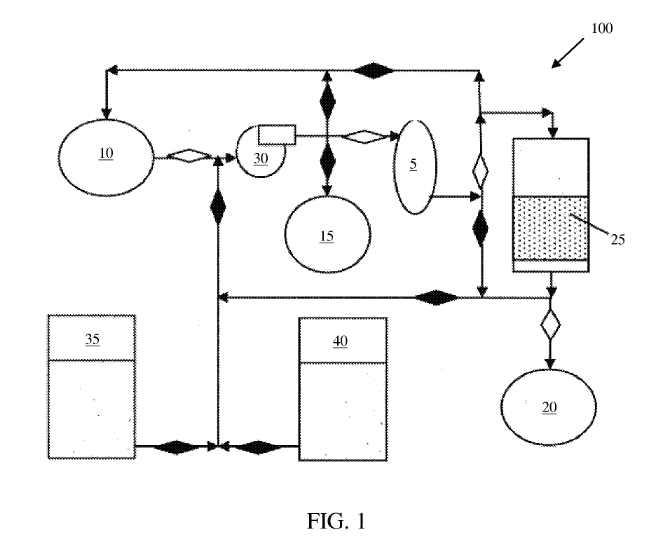

Once the resin bed becomes exhausted and cannot accomplish any further exchange, and has significantly expanded to fill the volume of the resin bed portion of the vessel, it is preferably regenerated. Exhaustion of the resin bed is usually determined by the conductivity and pH surrounding the cation resin bed shown as CN1, pH1 and CN2 and pH2 in FIG. 1. Once the drop in conductivity or pH across the resin bed falls below a given set amount, the resin will usually be considered exhausted and in need of regeneration. Typically, the resin bed will have a substantially tetrahedral cavity between the beads, equal to about ⅓ of the resin bed volume because the resin beads are typically substantially uniform in size. Therefore, contaminated water equal to about 1 resin bed volume should be trapped in the voids of the resin bed and top head space of the reaction vessel. This trapped contaminated water will typically be removed during the first and second regeneration steps, which are the backwash and first drain steps.

The regeneration process of the present invention is better understood with reference to FIGS. 1 to 8 hereof, which show the sequence of regeneration steps that will lead to a relatively low level of waste water discharge and minimum regenerant use. All of these figures show three separate liquid holding areas. The holding area for contaminated water to be treated by ion exchange is designated 10. The holding area for regenerant waste water is designated 15, and the holding area for the treated water is designated 20. These holding areas may be of any suitable type including natural ponds, artificial ponds, and tanks of suitable size without deviating from the scope of the invention. The treated water of course can be released to the environment. The regenerant waste water holding area 15 will preferably contain relatively high levels of sodium sulfate decahydrate (Glauber's salt) when sulfuric acid is used as the regenerant.

Additionally, certain symbols are used to describe certain functions in the following figures. For example, a white diamond typically indicates that a connection is made between the figure elements such that water or liquids may flow between the figure elements. A black diamond, on the other hand, typically indicates that no connection is made between the figure elements, such that water or liquids may not flow between the figure elements. Furthermore, an arrow typically refers to the direction of flow from one figure element to another.

FIG. 1 is a block diagram of one embodiment of the method for treating waste water and shows when the ion exchange resin bed is in service and when contaminated water is passed downward through the resin bed and into the treated water holding area. As shown in FIG. 1, the method for treating waste water 100 preferably includes: a filter 5; contaminated water 10; regenerant waste water 15; treated water 20; resin bed 25; pump 30; acid mix tank 35; and rinse tank 40. Specifically, FIG. 1 shows that once the resin bed 25 becomes exhausted, service is preferably stopped. At this point the resin bed 25 should contain approximately one bed volume of contaminated water 10 that has not been ion exchanged.

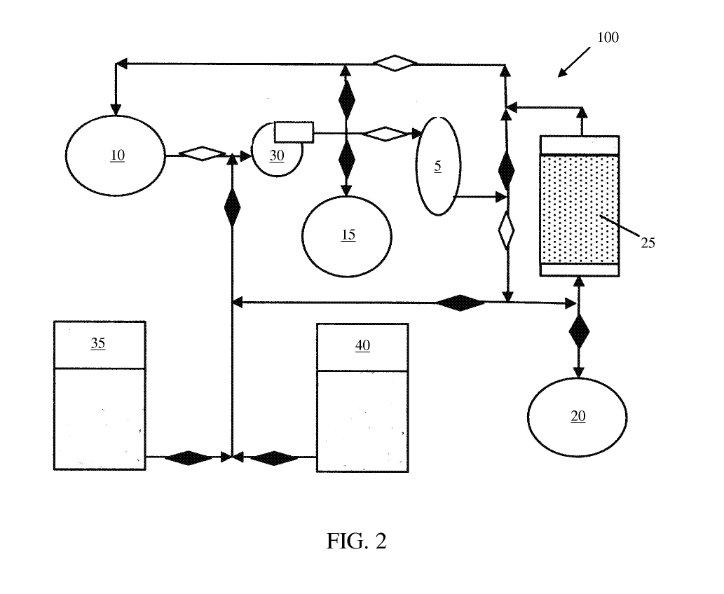

FIG. 2 is a block diagram of one embodiment of the method for treating waste water and shows the backwashing of the resin bed with an up-flow of filtered water. As shown in FIG. 2, the method for treating waste water 100 preferably includes: a filter 5; contaminated water 10; regenerant waste water 15; treated water 20; resin bed 25; pump 30; acid mix tank 35; and rinse tank 40. Specifically, FIG. 2 shows that the suspended solid that have been trapped in the resin bed 25 during service are preferably removed by backwashing the resin bed 25 with an up-flow at approximately 50% of process flow of an appropriate amount (two bed volumes) of filtered water from the contaminated water 10 holding area. In cases of severe suspended solids loading, it may be necessary to air mix after an initial backwash. This should dislodge suspended solids sticking to the resin beads. The backwash step can then be repeated. Removing these suspended solids is important because if any suspended solids are not removed from the resin bed 25, the resin bed 25 may plug-up and cause problems with water quality and/or throughput. The backwash also preferably redistributes the resin for better flow without channeling.

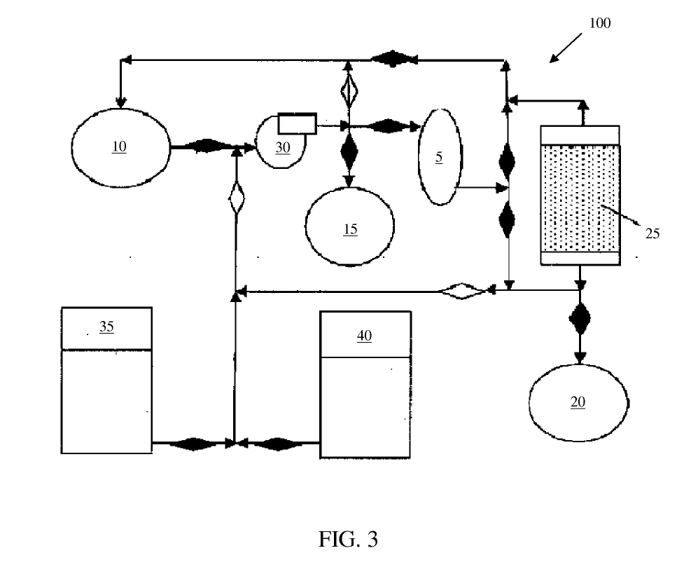

FIG. 3 is a block diagram of one embodiment of the method for treating waste water and shows the water draining from the reaction vessel. As shown in FIG. 3, the method for treating waste water 100 preferably includes: a filter 5; contaminated water 10; regenerant waste water 15; treated water 20; resin bed 25; pump 30; acid mix tank 35; and rinse tank 40. Specifically, FIG. 3 shows that once backwash is complete, the water in the reaction vessel is typically completely drained via the pump 30 (e.g., main transfer pump) and should be discharged back to the contaminated water 10 holding area. Preferably, each transfer pump will be equipped with a variable frequency drive (VFD) to allow the pump to run from approximately 10% to 100% of full process flow. Preferably, the flow for regeneration is approximately 25% and backwash will be at approximately 50% of full process flow.

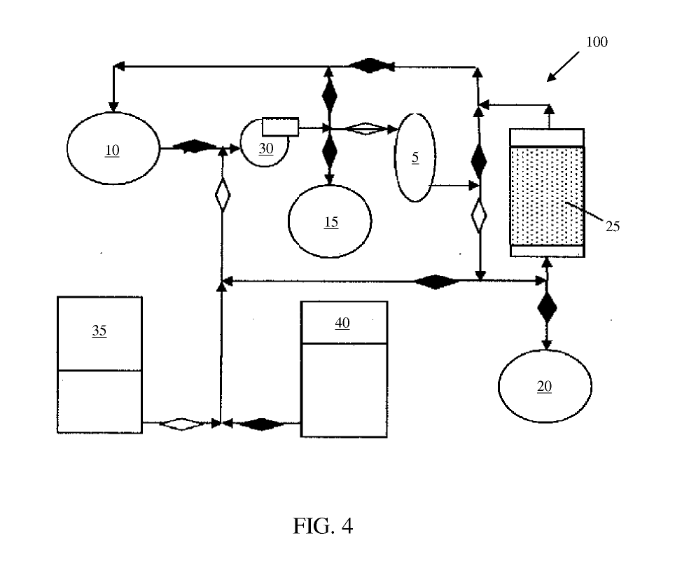

FIG. 4 is a block diagram of one embodiment of the method for treating waste water and shows the pumping of regenerant from the acid mix tank into the resin bed. As shown in FIG. 4, the method for treating waste water 100 preferably includes: a filter 5; contaminated water 10; regenerant waste water 15; treated water 20; resin bed 25; pump 30; acid mix tank 35; and rinse tank 40. Specifically, FIG. 4 shows that the next step in the regeneration procedure wherein a dilute stream of a strong acid (regenerant) of effective strength and at a temperature of about 30° C. to about 50° C. is preferably pumped from the acid mix tank 35 via the pump 30 (e.g., main transfer pump) and is preferably passed through the bottom distributor of the reaction vessel and into the resin bed 25 of exhausted ion exchange resin where hydrogen ions from the acid are exchanged for sodium, calcium and magnesium atoms on the resin beads. The flow of acid regenerant is typically continued until one bed volume of acid is dispensed and then the pump 30 is preferably stopped. Although any strong mineral acid can be used in the practice of the present invention hydrochloric acid and sulfuric acid are typically preferred with sulfuric acid being more preferably. Any strong mineral acid may be used for this step, but 1N to 2N sulfuric acid is typically preferred. Although weak acids, such as citric acid and acetic may be used, weak acids are typically more expensive and typically less effective than strong acids, producing more waste. The resin bed 25 is typically washed with the aqueous acid solution for about 15 to about 50 minutes, preferably from about 20 to about 40 minutes. Two resin bed volumes of regenerant is preferably used and is typically delivered in two substantially equal one resin bed volume portions. By “one resin bed volume,” it is preferably understood that volume in the vessel that is occupied by the ion exchange resin is one bed volume. The FIGS. hereof preferably show a single acid mix tank 35 sized for two bed volumes of acid solution.

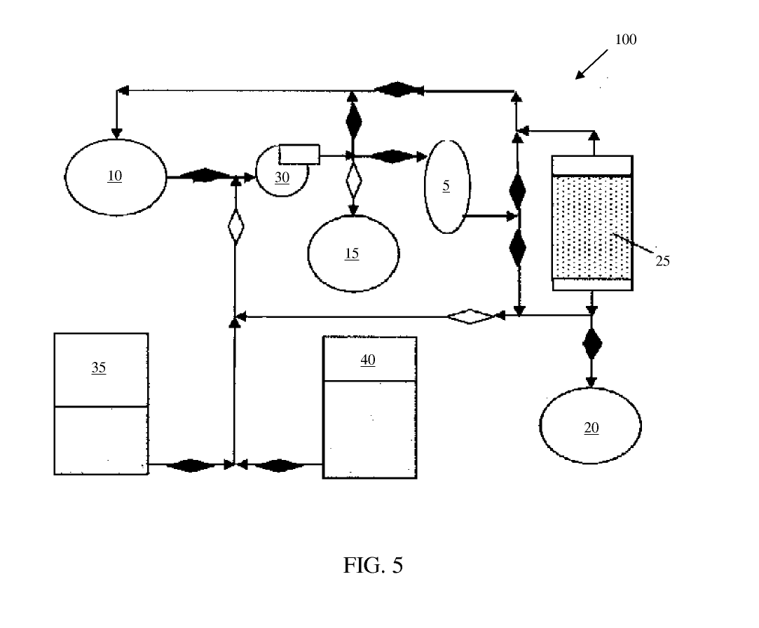

FIG. 5 is a block diagram of one embodiment of the method for treating waste water and shows the drain sequence of the regenerant liquid. As shown in FIG. 5, the method for treating waste water 100 preferably includes: a filter 5; contaminated water 10; regenerant waste water 15; treated water 20; resin bed 25; pump 30; acid mix tank 35; and rinse tank 40. Specifically, FIG. 5 shows that the regenerant liquid preferably drains from the reaction vessel with the discharge into the regenerant waste water 15 holding area. Once the reaction vessel is empty as indicated by flow rate, the pump 30 preferably stops. The remaining one bed volume of acid regenerant in the acid mix tank 35 is preferably pumped at approximately 25% of process flow into the bottom of the reaction vessel and into the resin bed 25, as illustrated in FIG. 4, and then the pump 30 will preferably stop again. Then the reaction vessel will preferably be drained again via the pump 30 into the regenerant waste water 15 holding area as illustrated in FIG. 5, and then the pump 30 will preferably stop based on low flow when the reaction vessel is empty.

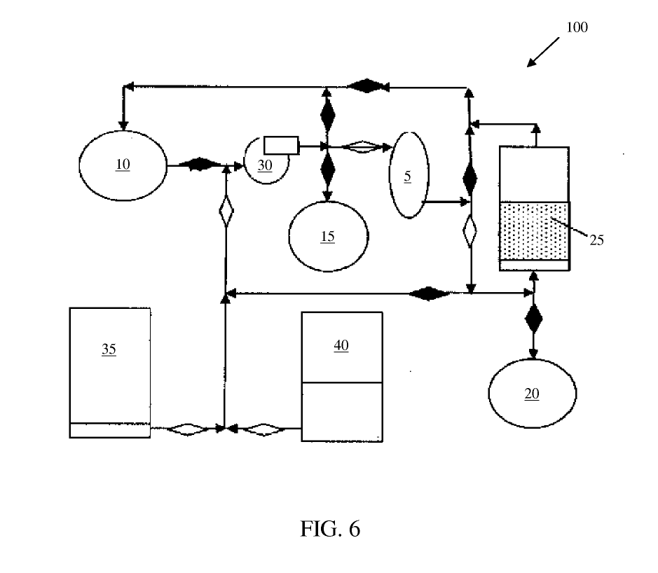

FIG. 6 is a block diagram of one embodiment of the method for treating waste water and shows the first rinse step. As shown in FIG. 6, the method for treating waste water 100 preferably includes: a filter 5; contaminated water 10; regenerant waste water 15; treated water 20; resin bed 25; pump 30; acid mix tank 35; and rinse tank 40. Specifically, FIG. 6 shows the first rinse step where one resin bed volume of rinse water from the rinse tank 40 is preferably pumped at approximately 25% of process flow into the bottom of the reaction vessel and preferably up through the resin bed 25. The reaction vessel is preferably again drained via pump 30 and discharged to the regenerant water 15 holding area as illustrated by FIG. 5. The reaction tank is then again filled with one bed volume of rinse water from the rinse tank 40 via pump 30 until the reaction tank is full of water as illustrated in FIG. 6.

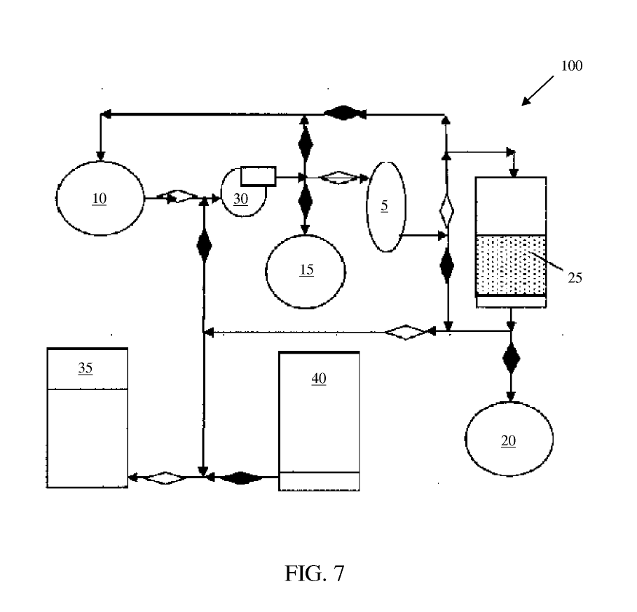

FIG. 7 is a block diagram of one embodiment of the method for treating waste water and shows the introduction of two bed volumes of rinse water that is discharged into the acid mix tank. As shown in FIG. 7, the method for treating waste water 100 preferably includes: a filter 5; contaminated water 10; regenerant waste water 15; treated water 20; resin bed 25; pump 30; acid mix tank 35; and rinse tank 40. Specifically, FIG. 7 shows that two bed volumes of rinse water is preferably introduced from the contaminated water 10 holding area into the top of the reaction vessel and down through the resin bed 25, and is preferably discharged into the acid mix tank 35. While water is typically introduced into the acid mix tank 35, the appropriate amount of bulk acid is preferably added to the acid mix tank 35 and is typically mixed with the incoming rinse water to prepare the regenerant solution for the next regeneration.

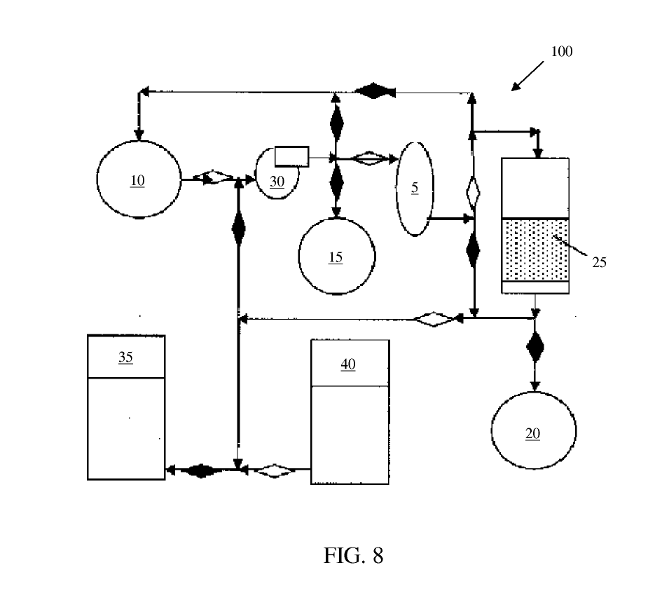

FIG. 8 is a block diagram of one embodiment of the method for treating waste water and shows the introduction of two bed volumes of rinse water that is discharged into the rinse tank. As shown in FIG. 8, the method for treating waste water 100 preferably includes: a filter 5; contaminated water 10; regenerant waste water 15; treated water 20; resin bed 25; pump 30; acid mix tank 35; and rinse tank 40. Specifically, FIG. 8 shows that two bed volumes of rinse water is preferably introduced from the contaminated water 10 holding area into the top of the reaction vessel and down through the resin bed 25 and discharged into the rinse tank 40. After the final rinse is complete, the reaction vessel is now ready for service again.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for treating a contaminated water stream, the steps comprising:
providing at least one reaction vessel;
providing at least one transfer pump;
wherein said at least one transfer pump furnishes a water and a regeneration flow to said at least one reaction vessel;
introducing said contaminated water stream into said at least one reaction vessel;
wherein said contaminated water contacts one or more ion exchange resin beads at an effective downflow rate sufficient to exchange one or more hydrogen ions of said exchange resin beads, such that a cation exchanged treated water stream is produced;
conducting said cation exchanged treated water stream from said at least one reaction vessel; and
stopping a flow of said contaminated water stream to said at least one reaction vessel when said one or more ion exchange resin beads is exhausted.

2. The method for treating a contaminated water stream of claim 1, further comprising the step of:
regenerating said one or more ion exchange resin beads.

3. The method for treating a contaminated water stream of claim 1, wherein said at least one reaction vessel contains one or more bed volumes of weak acid.

4. The method for treating a contaminated water stream of claim 3, wherein said one or more bed volumes of weak acid is approximately half of said at least one reaction vessel.

5. The method for treating a contaminated water stream of claim 1, wherein said at least one reaction vessel contains one or more bed volumes of strong acid cation exchange resin beds.

6. The method for treating a contaminated water stream of claim 5, wherein said at least one reaction vessel of said one or more bed volumes of strong acid cation exchange resin beds is approximately three quarters full.

7. The method for treating a contaminated water stream of claim 4, further comprising the step of:
removing one or more anions by providing an anion reaction vessel in series with said one or more bed volumes of strong acid cation exchange resin beds; and
wherein said anion reaction vessel is filled with a strong base resin in proportion to a level of an anionic loading.

8. The method for treating a contaminated water stream of claim 1, further comprising the step of:
introducing said contaminated water through a strong base anion reaction vessel.

9. The method for treating a contaminated water stream of claim 1, wherein said at least one reaction vessel is introduced to a degassifier.

10. The method for treating a contaminated water stream of claim 2, wherein said regenerating step comprises the steps of:
backwashing said exhausted one or more ion exchange resin beads at approximately 50% of the process flow;
draining said at least one reaction vessel of said water into a contaminated water holding area;
providing at least two ion exchange resin bed volumes of acid regenerant solution in an acid mix tank;
introducing into said one or more ion exchange resin beads said at least two ion exchange resin bed volumes of acid regenerant solution from said acid mix tank;
draining said at least one reaction vessel;
filling said at least one reaction vessel with a rinse water;
introducing a second of at least two resin bed volumes with said rinse water;
restarting a downflow of said contaminated water through said regenerated one or more ion exchange resin beads; and
repeating said regenerating step.

11. A method for treating a contaminated water stream, the steps comprising:
providing at least one reaction vessel;
providing at least one transfer pump;
wherein said at least one transfer pump furnishes a water and a regeneration flow to said at least one reaction vessel;
introducing said contaminated water stream through a main transfer pump from a contaminated water holding area into said at least one reaction vessel;
wherein said contaminated water contacts one or more ion exchange resin beads at an effective downflow rate sufficient to exchange one or more hydrogen ions of said exchange resin beads, such that a cation exchanged treated water stream is produced;
conducting said cation exchanged treated water stream from said at least one reaction vessel to a treated water holding area;
stopping a flow of said contaminated water stream to said at least one reaction vessel when said one or more ion exchange resin beads is exhausted; and
regenerating said one or more ion exchange resin beads.

12. The method for treating a contaminated water stream of claim 11, wherein said at least one reaction vessel contains one or more bed volumes of weak acid; and
wherein said one or more bed volumes of weak acid are substantially spherical.

13. The method for treating a contaminated water stream of claim 12, wherein said one or more bed volumes of weak acid is approximately half of said at least one reaction vessel; and
wherein said one or more bed volumes of weak acid is encompassed by one or more surrounding walls of said at least one reaction vessel.

14. The method for treating a contaminated water stream of claim 11, wherein said at least one reaction vessel contains one or more bed volumes of strong acid cation exchange resin beds; and
wherein said one or more bed volumes are substantially spherical;

15. The method for treating a contaminated water stream of claim 14, wherein said at least one reaction vessel of said one or more bed volumes of strong acid cation exchange resin beds is approximately three quarters full.

16. The method for treating a contaminated water stream of claim 15, further comprising the step of:
removing one or more anions by providing an anion reaction vessel in series with said one or more bed volumes of strong acid cation exchange resin beds; and
wherein said anion vessel is filled with a strong base resin in proportion to a level of anionic loading.

17. The method for treating a contaminated water stream of claim 11, further comprising the step of:
introducing said contaminated water through a strong base anion reaction vessel.

18. The method for treating a contaminated water stream of claim 11, wherein said at least one reaction vessel is introduced to a degassifier.

19. The method for treating a contaminated water stream of claim 11, wherein said regenerating step comprises the steps of:
backwashing said exhausted one or more ion exchange resin beads at approximately 50% of the process flow;
draining said at least one reaction vessel of said water into a contaminated water holding area;
providing at least two ion exchange resin bed volumes of an acid regenerant solution in an acid mix tank;
introducing into said one or more ion exchange resin beads said at least two exchange bed volumes of said acid regenerant solution from said acid mix tank;
draining said at least one reaction vessel;
introducing a second of resin bed volumes of said acid regenerant solution;
draining said at least one reaction vessel a second time;
introducing one bed volume of a rinse water into said at least one reaction vessel and into said resin bed volumes of said acid regenerant solution;
draining said at least one reaction vessel a third time;
filling said at least one reaction vessel with said rinse water;
introducing at least two resin bed volumes with said rinse water;
introducing an additional two resin bed volumes of rinse water from said contaminated water holding area;
restarting a downflow of said contaminated water through said regenerated one or more ion exchange resin beads; and
repeating said regenerating step whenever said one or more ion exchange resin beads becomes exhausted.

20. A method for treating a contaminated water stream, the steps comprising:
providing at least one reaction vessel;
wherein said at least one reaction vessel contains one or more bed volumes of strong acid cation exchange resin beds;
wherein said one or more bed volumes of strong acid cation exchange resin beds are substantially spherical;
wherein said at least one reaction vessel of said one or more bed volumes of strong acid cation exchange resin beds is approximately three quarters full;
providing an anion reaction vessel in series with said one or more bed volumes of strong acid cation exchange resin beds;
wherein said anion vessel is filled with a strong base resin in proportion to a level of anionic loading;
providing at least one transfer pump;
wherein said at least one transfer pump includes said at least one reaction vessel to furnish a water and a regeneration flow to said at least one reaction vessel;
introducing said contaminated water stream into said at least one reaction vessel;
introducing said contaminated water through a strong base anion reaction vessel;
wherein said contaminated water contacts one or more ion exchange resin beads at an effective downflow rate sufficient to exchange one or more hydrogen ions of said exchange resin beads for one or more cations of said contaminated waters stream, such that a cation exchanged treated water stream is produced;
wherein said at least one reaction vessel is introduced to a degassifier;
conducting said cation exchanged treated water stream from said at least one reaction vessel to a treated water holding area;
stopping a flow of said contaminated water stream to said at least one reaction vessel when said one or more ion exchange resin beads is exhausted;
regenerating said one or more ion exchange resin beads, said regenerating step comprises the steps of:
backwashing said exhausted one or more ion exchange resin beads at approximately 50% of the process flow;
draining said at least one reaction vessel of said water into a contaminated water holding area;
providing at least two ion exchange resin bed volumes of acid regenerant solution in an acid mix tank;
introducing into said one or more ion exchange resin beads said at least two ion exchange resin bed volumes of acid regenerant from said acid mix tank;
draining said at least one reaction vessel;
introducing a second resin bed volume of said acid regenerant solution;
draining said at least one reaction vessel a second time;
introducing at least one bed volume of a rinse water into said at least one reaction vessel and into said at least two ion exchange resin bed volumes of said acid regenerant solution;
draining said at least one reaction vessel a third time;
filling said at least one reaction vessel with said rinse water;
introducing a second of at least two resin bed volumes of rinse water from said contaminated water holding area;
restarting a downflow of said contaminated water through said regenerated one or more ion exchange resin beads; and
repeating said regenerating step whenever said one or more ion exchange resin beads becomes exhausted.
